(19) United States
(12) Patent Application Publication
(10) Pub. No.: US 2020/0294089 A1
(43) Pub. Date: Sep. 17, 2020

(54) Calculating Customer Interest In Merchant Communications

(71) Applicant: Square, Inc., San Francisco, CA (US)

(72) Inventors: Collin S. Wikman, San Francisco, CA (US); Tyler Kovacs, San Francisco, CA (US); Zachary Chase Abrams, San Francisco, CA (US)

(21) Appl. No.: 14/546,541

(22) Filed: Nov. 18, 2014

(51) Int. Cl. G06Q 30/02

(52) U.S. Cl. CPC G06Q 30/0255

(57) ABSTRACT

This disclosure describes techniques to infer customer communication preferences based on interactions between customers and merchants. In the past, merchants have typically asked customers to either opt-in or opt-out from receiving subsequent communications from the merchants. However, many customers simply choose the default setting, such that the resultant “selection” does not adequately reflect their desires regarding whether and how much future communication they would like to receive. This often results in high unsubscribe rates and/or ineffective merchant communication. The described techniques utilize behavior of a customer as a more accurate gauge of how receptive the customer is to receiving communications from a merchant. The analyzed behavior may include how often a customer visits a particular merchant, for how long the customer remains at the merchant, how much money the customer has spent at the merchant, whether the customer has previously responded to communication sent by the merchant, and the like.

### BACKGROUND

In today's commerce, merchants often utilize multiple channels to connect with their customers. For instance, in addition to meeting the customer at physical and/or digital premises of the merchant, merchants also often communicate with their customers via email, mobile devices of the customers, physical mail, or the like. However, partly in order to more efficiently utilize their resources, merchants often request that their customers either opt-in or opt-out from receiving these merchant communications. Unfortunately, the traditional checkbox mechanism for making this decision often results in customers simply leaving the default selection undisturbed, resulting in poor performance of the communications (e.g., emails, etc.) sent by the merchants.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example environment that includes merchants operating respective point-of-sale (POS) devices to conduct transactions with an example customer, as well as a payment service to authorize a payment instrument of the customer. In some instances, the merchants and/or the payment service infer communication preferences of the customer based on how often the customer visits the merchants, how much the customer spends at the merchants, and the like. The payment service and/or the merchants can then utilize these inferred communication preferences when deciding whether to send future communications to the customer.

FIGS. 2A-B illustrate respective examples of calculating customer-interaction scores for respective customers and inferring communication preferences for these customers based on the scores.

FIG. 3 illustrates a flow diagram of a process for determining whether to opt-in or opt-out a customer from future communications from a merchant based on interactions between the customer and the merchant and/or similar merchants.

FIG. 4 illustrates a flow diagram of a process for inferring communication preferences to associated with a customer based on interactions between the customer and the merchant and/or similar merchants.

FIG. 5 illustrates select components of a POS device that merchants described herein may utilize.

### DETAILED DESCRIPTION

This disclosure describes, in part, techniques to infer customer communication preferences based on interactions between customers and merchants. In the past, merchants have typically asked customers to either opt-in or opt-out from receiving subsequent communications from the merchants. However, many customers simply choose the default setting, such that the resultant “selection” does not adequately reflect their desires regarding whether and how much future communication they would like to receive. This often results in high unsubscribe rates and/or ineffective merchant communication.

In contrast, the techniques described herein utilize behavior of a customer as a more accurate gauge of how receptive the customer is to receiving communications from a merchant. The analyzed behavior may include how often a customer visits a particular merchant, for how long the customer remains at the merchant (e.g., a physical premises or a digital presence of the merchant), how much money the customer has spent at the merchant, whether the customer has previously responded to communication sent by the merchant, and the like. In addition, the techniques may analyze the customer's behavior at other merchants, such as merchants that have been deemed similar to the merchant at hand.

Based on the behavior of the customer, the techniques may calculate a customer-interaction score representing an amount of interaction between a customer and one or more merchants. Typically, a higher score may correspond to more interaction, such as more frequent visits to the merchant, longer visits, more money spent, greater response to past merchant communications, and the like. After calculating this score, the techniques may then infer communication preferences of the customer based on this score. For instance, the techniques may infer that customers associated with relatively high customer-interaction scores will be more receptive to merchant communications than customers with lower scores. Of course, in other implementations, the opposite may be inferred.

In some instances, the techniques may compare a customer-interaction score of a customer to a threshold (or multiple thresholds). If the score is greater than the threshold, the techniques may associate the customer with a first level of merchant communication. Conversely, the techniques may associate the customer with a second level of communication if the score is less than the threshold. In one example, customers having a customer-interaction, score for a particular merchant that is greater than the threshold may be deemed to have opted-in to subsequent merchant communications and, hence, may begin receiving these communications. Conversely, customers having scores lower than this threshold may be deemed to have opted out. In other examples, the techniques may associate different levels of merchant contact based on the customer-interaction scores. For instance, customer having higher scores may receive more communication from a merchant than customers having lower scores.

By inferring customer receptivity to merchant communication based on customer behavior, the techniques may allow a merchant to communicate to those customers that are receptive to such communication, while avoiding “spamming” those customers who likely are not.

For discussion purposes, some example implementations are described below with reference to the corresponding figures. However, implementations herein are not limited to the particular examples provided, and may be extended to other environments, other system architectures, other types of merchants, and so forth, as will be apparent to those of skill in the art in light of the disclosure herein.

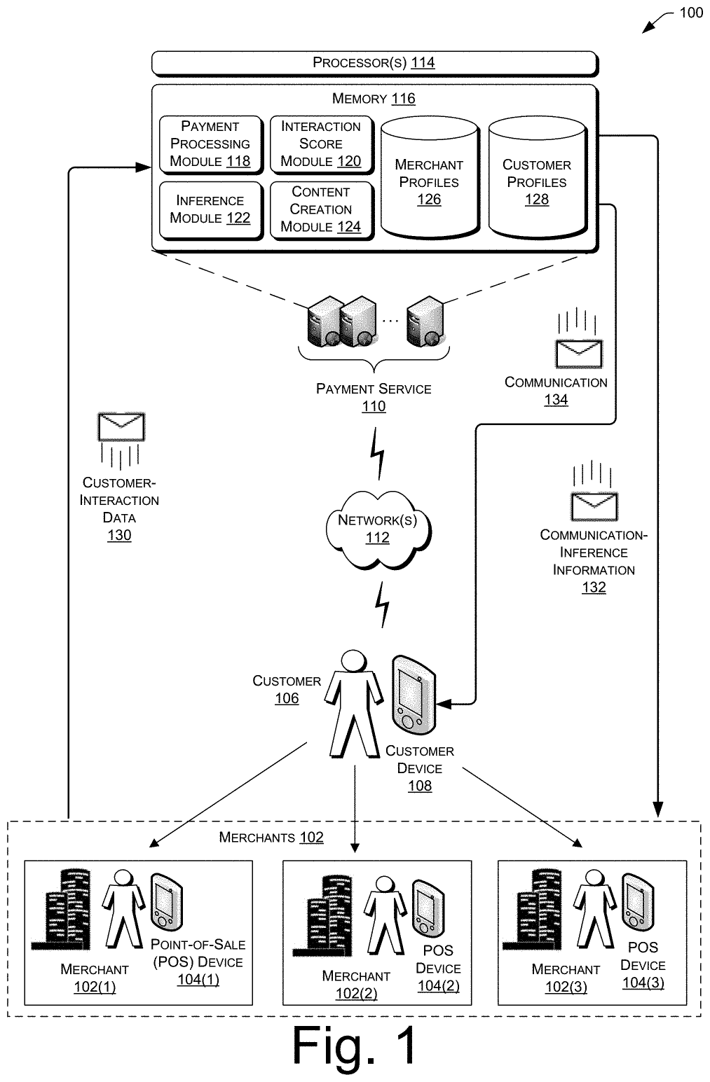

FIG. 1 illustrates an example environment 100 that includes multiple merchants 102(1), 102(2) and 102(3) (collectively “merchants 102”) operating respective point-of-sale (POS) devices 104(1), 104(2), and 104(3) to engage in various transactions with customers, such as an example customer 106 (here, associated with an example customer device 108). The POS devices 104(1)-(3) may comprise any sort of mobile or non-mobile device that includes an instance of a merchant application that executes on the respective device. The merchant application may provide POS functionality to the POS devices 104(1)-(3) to enable the merchants 102 (e.g., owners, employees, etc.) to accept payments from the customer 106. In some types of businesses, the POS devices 104(1)-(3) may correspond to a store or other place of business of the merchant, and thus, may be a fixed location that typically does not change on a day-to-day basis. In other types of businesses, however, the POS devices 104(1)-(3) may change from time to time, such as in the case that a merchant operates a food truck, is a street vendor, is a cab driver, etc., or has an otherwise mobile business, e.g., in the case of merchants who sell items at buyer's homes, places of business, and so forth.

As used herein, a merchant may include any business engaged in the offering of goods or services for acquisition by customers. Actions attributed to a merchant may include actions performed by owners, employees, or other agents of the merchant and thus no distinction is made herein unless specifically discussed. In addition, as used herein, a customer may include any entity that acquires goods or services from a merchant, such as by purchasing, renting, leasing, borrowing, licensing, or the like. Hereinafter, goods and/or services offered by merchants may be referred to as items. Thus, a merchant and a customer may interact with each other to conduct a transaction in which the customer acquires an item from a merchant, and in return, the customer provides payment to the merchant.

As used herein, a transaction may include a financial transaction for the acquisition of goods and/or services that is conducted between a customer and a merchant. For example, when paying for a transaction, the customer can provide the amount that is due to the merchant using a payment instrument (e.g., a debit card, a credit card, a stored-value or gift card, a check, through an electronic payment application on a device carried by the customer, or the like). The merchant can interact with the POS devices 104(1)-(3) to process the transactions, such as by inputting (e.g., manually, via a magnetic card reader or an RFID reader, etc.) identifiers associated with the payment instruments. For example, a payment instrument of one of the customers 106 may include one or more magnetic strips for providing card and customer information when swiped in a card reader. In other examples, other types of payment cards may be used, such as smart cards having a built-in memory chip that is read by the devices 104(1)-(3) when the card is “dipped” into the reader, a radiofrequency identification tag, or so forth.

During the transaction, the POS devices 104(1)-(3) can determine transaction information describing the transaction, such as the identifier of the payment instrument, an amount of payment received from the customer, the item(s) acquired by the customer, a time, place and date of the transaction, a card network associated with the payment instrument, an issuing bank of the payment instrument, and so forth. The POS devices 104(1)-(3) can send the transaction information to a payment service 110 over a network 112, either substantially contemporaneously with the conducting of the transaction (in the case of online transactions) or later when the device 104 is in the online mode (in the case offline transactions).

In an offline transaction, the POS device 104 may store one or more characteristics associated with the transaction (i.e., the transaction information), such as a cost of the transaction, a time of day at which the transaction occurred, a day of the week at which the transaction occurred, a location at which the transaction took place, an item that the customer obtained, and a payment instrument used in the transaction. After conducting an offline transaction with one of the customers 106, the POS device 104 may provide the stored information to the payment service 110 over the network 112. The network 112 may represent any one or more wired or wireless networks, such as a WiFi network, a cellular network, or the like. In an online transaction, the POS device may send this information to the payment service 110 over the network 112 substantially contemporaneously with the transaction with the customer.

As illustrated, the payment service 110 may include one or more processors 114 and memory 116. The memory 116 may store a payment processing module 118, an interaction score module 120, an inference module 122, a content creation module 124, a datastore 126 storing one or more merchant profiles, and a datastore 128 storing one or more customer profiles.

The payment processing module 118 may function to receive the information regarding a transaction from one of the POS devices 104(1)-(3) and attempt to authorize the payment instrument used to conduct the transaction. The payment processing module 118 may then send an indication of whether the payment instrument has been approved or declined back to the POS device.

Generally, when a customer and a merchant enter into an electronic payment transaction, the transaction is processed by electronically transferring funds from a financial account associated with the customer to a financial account associated with the merchant. As such, the payment processing module 118 may communicate with one or more computing devices of a card network (or “card payment network”), e.g., MasterCard®, VISA®, over the network 112 to conduct financial transactions electronically. The payment processing module 118 can also communicate with one or more computing devices of one or more banks over the network 112. For example, the payment processing module 118 may communicate with an acquiring bank, and/or an issuing bank, and/or a bank maintaining customer accounts for electronic payments.

An acquiring bank may be a registered member of a card association (e.g., Visa®, MasterCard®), and may be part of a card payment network. An issuing bank may issue credit cards to buyers, and may pay acquiring banks for purchases made by cardholders to which the issuing bank has issued a payment card. Accordingly, in some examples, the computing device(s) of an acquiring bank may be included in the card payment network and may communicate with the computing devices of a card-issuing bank to obtain payment. Further, in some examples, the customer may use a debit card instead of a credit card, in which case, the bank computing device(s) of a bank corresponding to the debit card may receive communications regarding a transaction in which the customer is participating. Additionally, there may be computing devices of other financial institutions involved in some types of transactions or in alternative system architectures, and thus, the foregoing are merely several examples for discussion purposes.

In some instances, computing devices associated with the merchants 102 (e.g., POS devices 104(1)-(3), servers of the merchant, etc.) determine when the customer 106 visits physical premises or a digital presence of the merchants 102. For instance, the customer device 108 may also include an application (e.g., an application provided by the payment service 110) that communicates with the POS devices 104(1)-(3) via near-field communication methods (e.g., Bluetooth, etc.). Therefore, when the customer visits the physical premises of the merchant 102(1), for example, the POS device 104(1) may detect the presence of the customer device 108. The POS device 104(1) may accordingly determine that the customer 106 is present, and may log a length of stay of the customer. In some instances, the customer device 108 includes an instance of an application, from the payment service, that allows the customer 106 to pay for items at the merchant 102(1) using the application. In these instances, the application on the customer device 108 is linked to one or more payment instruments of the customer.

In addition to determining when the customer 106 is present at the merchant 102(1) via near-field communication, the merchant 102(1) may determine the customer's presence in any other number of ways. For instance, when the customer engages in a transaction with the merchant 102(1), the customer 106 may provide a payment instrument to the merchant 102(1). In response, the merchant 102(1) inputs information regarding the payment instrument into the POS device 104(1), which provides this information to the payment service 110 as part of requesting authorization of the payment instrument for the transaction. The payment service 110 may map the payment instrument to the customer 106 and, hence, may deduce that the customer 106 was located at the merchant 102.

In another example, the customer may utilize the customer device 108 to “check in” at the merchant location, and the POS device 104(1) may receive an indication of this check in. When the customer visits a digital presence of the merchant 102(1) (e.g., a website, etc.), the customer 106 may log in or otherwise provide information (e.g., a cookie on the device 108) from which the merchant 102 determines that the customer 106 was at the merchant. Of course, while a few examples are listed, it is to be appreciated that the merchant 102(1) and/or the payment service 110 may determine when the customer 106 is present at the merchant in any other number of ways.

In addition to determining how often and/or how long the customer 106 visits the merchant 102(1), the merchant 102(1) and/or the payment service 110 may also determine how much money the customer 106 spends at the merchant. This information may be tracked for the life of a customer, or over a particular amount of time (e.g., in the past month, past year, etc.).

After the merchant 102(1) collects information associated with its interaction with the customer 106, the POS device or other computing device of the merchant 102(1) may send this information to the payment service 110. For instance, FIG. 1 illustrates the merchants 102 providing customer-interaction data 130 to the payment service 110. As described above, this data 130 may include how often customers, such as the customer 106, visit, how long they stay, how much money they spend, and the like. The payment service 110 may use this data 130 to infer receptivity of the customers to future communications from the merchants 102.

For instance, the payment service 110 may receive information from the merchant 102(1) regarding how often the customer 106 has visited, how long the customer 106 stayed at the merchant, an amount of money that the user spent, a type of item acquired by the customer 106, or the like. In addition, the payment service 110 may identify merchants that are similar to the merchant 102(1) and may analyze this data as well. For instance, the payment service 110 may identify merchants that share one or more attributes with the merchant 102(1), such as offering a same category of items, being classified in a same manner (e.g., restaurant, Thai restaurant, toy store, etc.), or the like. The payment service 110 may then analyze this data, in addition to the data from the merchant 102(1), to infer the communication preferences or receptivity of the customer 106.

To do so, the interaction score module 120 may receive the customer-interaction data 130. Using this data, the module 120 may calculate a score for the customer 106 with regards to the merchant 102(1). That is, this score may represent an amount of interaction between the customer 106 and the merchant 102(1) and/or merchants that have been deemed similar to the merchant 102(1). Again, this score may be based on how often the customer 106 visits the merchant 102(1), the length of the stays, the amount of spend, and the like. Generally, more and longer visits, as well as greater spend amounts, will equate to a higher interaction score.

After the interaction score module 120 calculates a score for the customer 106, the inference module 122 may infer one or more communication preferences of the customer 106. For instance, the inference module 122 may determine, based on the interaction score calculated above, that the customer 106 should be opted-in to receive future communications from the merchant 102(1) (and potentially similar merchants). These communications may include emails, surveys, coupons, solicitations for feedback, promotions, newsletters, or the like. In another example, the inference module 122 may infer that the user should be opted-out from receiving these communications. In still other instances, the inference module 122 may determine any other level of contact. For instance, the inference module 122 may store, in the datastore 128, an indication that customers associated with interaction scores within a first range should receive a first level of contact from the merchant 102(1), customers associated with interaction scores within a second, higher range should receive a second, greater level of contact from the merchant 102(1), and so forth.

After inferring these communication preferences for the customer 106, the payment service 110 may send one or more communications to the customer 106 on behalf of the merchant 102(1) and/or may send an indication of the communication preferences to the appropriate merchants. For instance, FIG. 1 illustrates that the payment service 110 may send communication-preference information 132 to the merchant. Using the example above, for instance, the payment service 110 may send, to the merchant 102(1), an indication that the customer 106 should be deemed to have opted into receiving future communications from the merchant 102(1) based on the previous interactions between the customer 106 and the merchant 102(1) (and/or similar merchants). The merchant 102(1) may thereafter send one or more communications to the customer device 108 (for example).

In other instances, meanwhile, the payment service 110 may send communications 134 directly to the customer device 108 on behalf of the merchant 102(1). For example, the payment service 110 may send a coupon or survey to the customer device 108, based on the customer-interaction score indicating that the user is receptive to communication with the merchant 102(1). In some instances, the content creation module 124 may create content to communicate to the customer device 108, while in other instances the merchant 102(1) or another entity may provide the content to the payment service 110, which sends the content to the customer device 108 on behalf of the merchant.

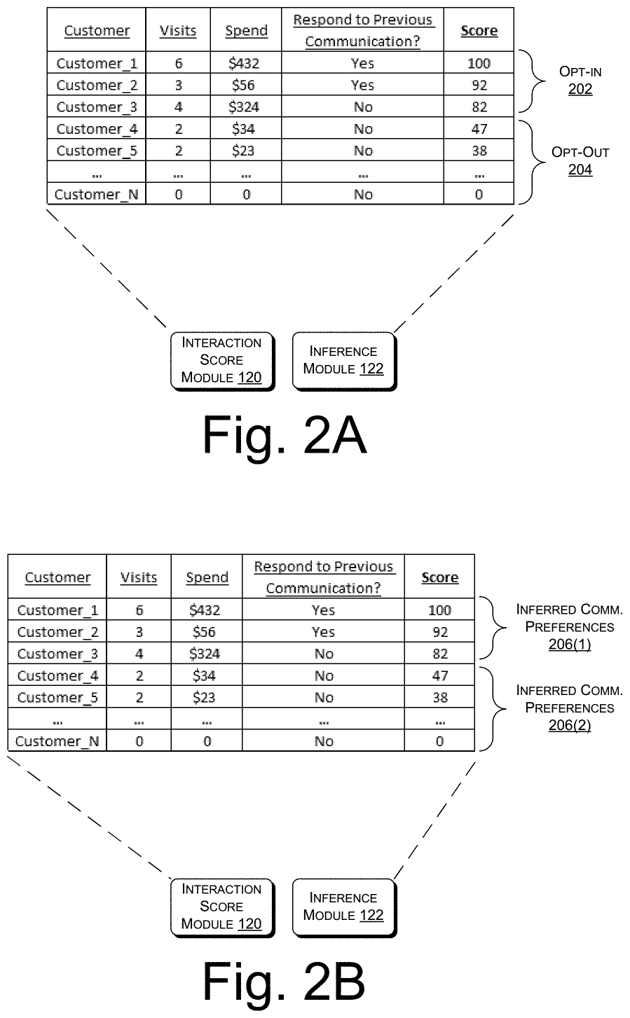

FIGS. 2A-B illustrate respective examples of calculating customer-interaction scores for respective customers and inferring communication preferences for these customers based on the scores. FIG. 2A, for instance, illustrates that the interaction score module 120 has calculated example interaction scores for customers 1-N. As illustrated, these scores may be based on a number of visits made by each customer to a particular merchant or related merchants (potentially over a predetermined amount of time, such as over the past month, year, etc.), an amount spent (e.g., average, over the predetermined amount of time, etc.), and whether the respective customer has responded to previous merchants communications. The module 120 then calculates an interaction score for these example customers, while the inference module 122 infers one or more communication preferences for these customers based on these scores. In the example of FIG. 2A, for instance, the inference module 122 has inferred, at 202, that customers having a score greater than a certain threshold (e.g., 50 on a normalized scale) should be opted in to receive future communications for a particular merchant, while inferring, at 204, that other customers should be opted out from these communications.

In some instances, the inference module 122 may infer any other type of communication preferences (other than simply opt-in/opt-out) based on the calculated customer interaction scores. FIG. 2B for instances, illustrates the inference module 122 utilizing the scores to assign, at 206, first communication preferences to a first set of users and, at 208, second communication preferences to a second set of users, and so forth. These preferences may indicate an amount of communication or contact between the merchant and the customers, types of communication, or the like.

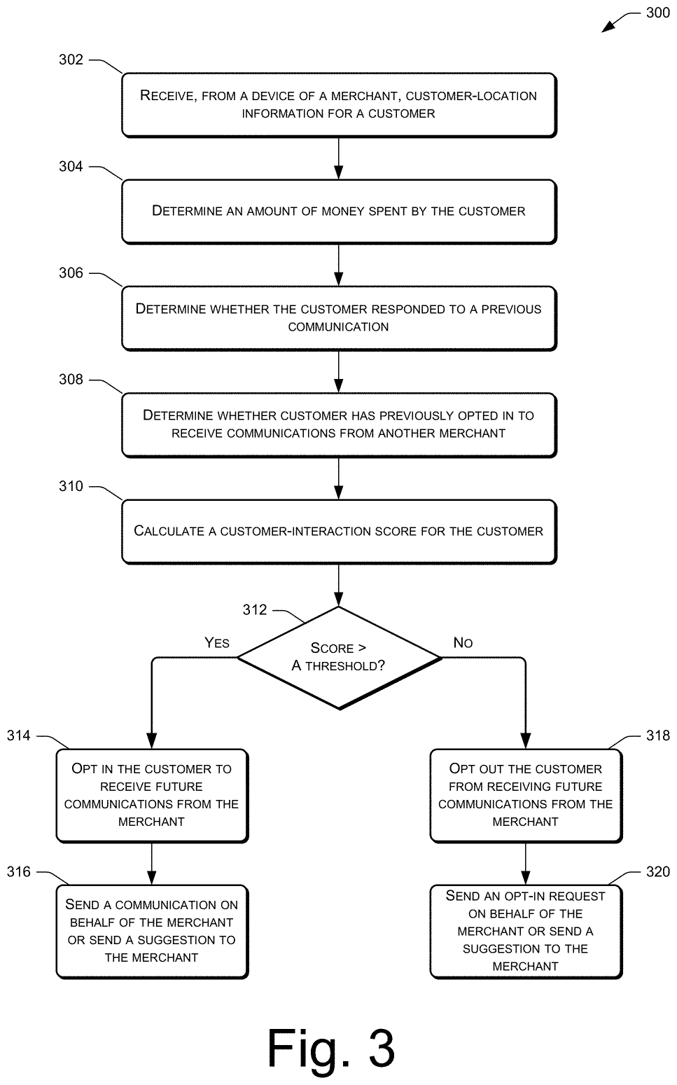

FIG. 3 illustrates a flow diagram of a process 300 for determining whether to opt-in or opt-out a customer from future communications with a merchant based on interactions between the customer and the merchant and/or similar merchants. The process 300 and other processes described herein are illustrated as collections of blocks in logical flow diagrams, which represent a sequence of operations, some or all of which can be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation. Any number of the described blocks can be combined in any order and/or in parallel to implement the process, or alternative processes, and not all of the blocks need be executed. For discussion purposes, the processes are described with reference to the environments, architectures and systems described in the examples herein, although the processes may be implemented in a wide variety of other environments, architectures and systems. The process 300, and other processes described herein, may be performed by a POS device, by a remote payment service (e.g., payment service 110), by another entity, or by a combination thereof.

At 302, the process 300 receives, from a device of a merchant, customer-location information for a customer. This information may indicate that a customer has visited a digital or physical presence of the merchant, which may be used to determine how often, how long, or the like the customer has frequented the merchant and/or similar merchants. At 304, the process 300 determines an amount of money spent by the customer at the merchant, potentially along with an item purchased or similar information. The process 300 may receive this information from the merchant device as well.

At 306, the process 300 determines whether the customer has responded to a previous communication from the merchant (and/or potentially from another merchant). For instance, if the merchant has previously sent an email or link to a device of the customer, then process 300 may determine whether the customer replied to the email, selected the link, or otherwise interacted with the previous merchant communication. At 308, the process 300 also determines whether the customer has previously opted in to receive communications from other merchants. For instance, the payment service 110 may determine whether the customer has previously requested to receive communications from other merchants that utilize the payment service 110.

At 310, the process 300 calculates a customer-interaction score for the customer with regards to the merchant, representing an amount of interaction that the customer has had with the particular merchant. This score may be calculated using some of all of the information collected above, potentially along with other information, such as whether the customer has previously explicitly opted in to receive communications from another merchant. In some instances, the process 300 applies a weight to each of these factors (i.e., frequency of visits, the amount of money spent, etc.) and may sum the weighted values to come up with the customer interaction score. In some instances, the weights may decay over time such that more recent interactions between the customer and the merchant are valued more highly than past interactions.

At 312, the process 300 determines whether the calculated customer-interaction score is greater than a threshold. If so (indicating that the customer has had a relatively larger amount of interaction with the merchant), then at 314 the process 300 opts in the customer to receive future communications from the merchant. That is, the process 300 may determine that the user has indicated, through his or her behavior at the merchant and/or similar merchants, receptivity to receiving future communications from the merchant. At 316, the process 300 may send, without an explicit request from the user, a communication to a device of the customer on behalf of the merchant and/or may suggest to the merchant that the merchant send subsequent communications to a device of the customer.

If, however, the calculated score is less than the threshold, then at 318 the process 300 opts out the customer from receiving communications from this merchant (i.e., may refrain from opting in the customer). At 320, the process 300 may instead send an opt-in request to the customer in order to allow the customer to explicitly opt-in to receiving these communications, or the process 300 may send a suggestion to the merchant to send this opt-in request to a device of the customer.

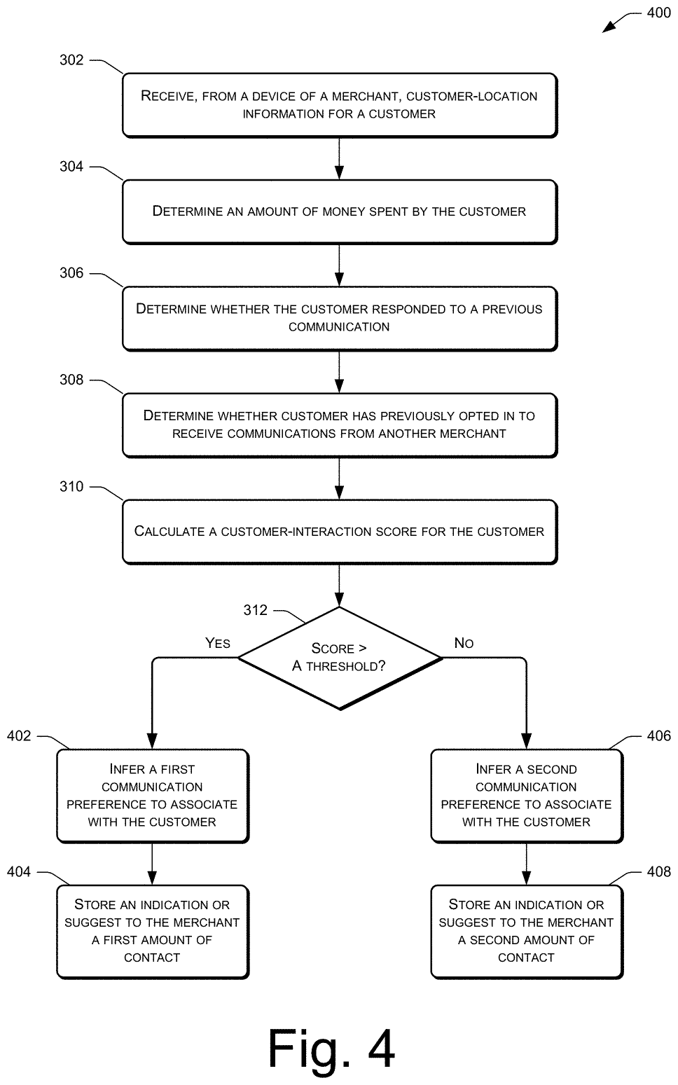

FIG. 4 illustrates a flow diagram of a process 400 for inferring communication preferences for a customer based on interactions between the customer and the merchant and/or similar merchants. In this example, the process 400 again includes the operations 302-312. Here, however, if the customer interaction score is greater than the threshold, then at 402 the process 400 infers a first communication preference to associate with the customer. At 404, the process 400 may then store an indication of this first communication preference associated with the customer or may suggest, to the merchant, that the merchant engage in a first amount of contact with the customer. If, however, the score is less than the threshold, then at 406 the process 400 infers a second communication preference to associate with the customer. At 408, the process 400 may then store an indication of this second communication preference associated with the customer or may suggest, to the merchant, that the merchant engage in a second amount of contact with the customer. In some instances, the first amount of contact is greater than the second amount of contact. Further, the process 400 may assign any number of communication preferences to a group of customers based on an interaction score of each respective customer.

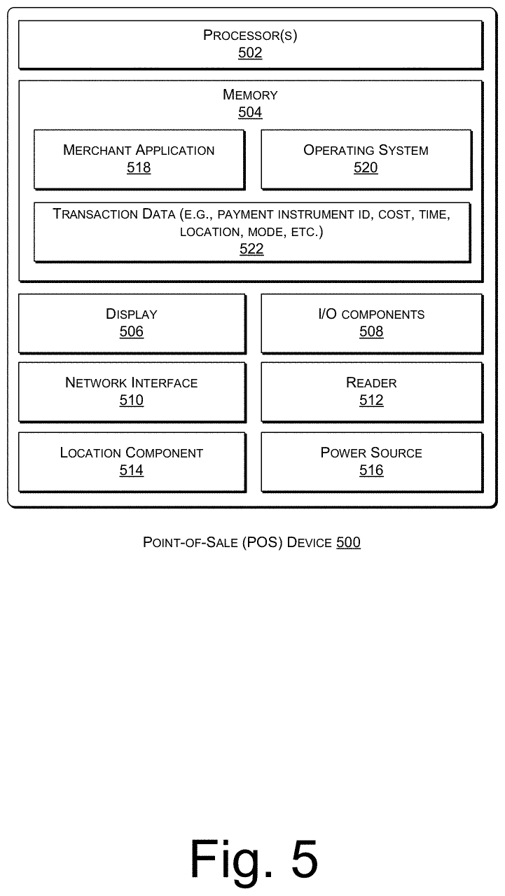

FIG. 5 illustrates select example components of an example POS device 500 according to some implementations. The POS device 500 may be any suitable type of computing device, e.g., mobile, semi-mobile, semi-stationary, or stationary. Some examples of the POS device 500 may include tablet computing devices; smart phones and mobile communication devices; laptops, netbooks and other portable computers or semi-portable computers; desktop computing devices, terminal computing devices and other semi-stationary or stationary computing devices; dedicated register devices; wearable computing devices, or other body-mounted computing devices; or other computing devices capable of sending communications and performing the functions according to the techniques described herein.

In the illustrated example, the POS device 500 includes at least one processor 502, memory 504, a display 506, one or more input/output (I/O) components 508, one or more network interfaces 510, at least one card reader 512, at least one location component 514, and at least one power source 516. Each processor 502 may itself comprise one or more processors or processing cores. For example, the processor 502 can be implemented as one or more microprocessors, microcomputers, microcontrollers, digital signal processors, central processing units, state machines, logic circuitries, and/or any devices that manipulate signals based on operational instructions. In some cases, the processor 502 may be one or more hardware processors and/or logic circuits of any suitable type specifically programmed or configured to execute the algorithms and processes described herein. The processor 502 can be configured to fetch and execute computer-readable processor-executable instructions stored in the memory 504.

Depending on the configuration of the POS device 500, the memory 504 may be an example of tangible non-transitory computer storage media and may include volatile and nonvolatile memory and/or removable and non-removable media implemented in any type of technology for storage of information such as computer-readable processor-executable instructions, data structures, program modules or other data. The memory 504 may include, but is not limited to, RAM, ROM, EEPROM, flash memory, solid-state storage, magnetic disk storage, optical storage, and/or other computer-readable media technology. Further, in some cases, the POS device 500 may access external storage, such as RAID storage systems, storage arrays, network attached storage, storage area networks, cloud storage, or any other medium that can be used to store information and that can be accessed by the processor 502 directly or through another computing device or network. Accordingly, the memory 504 may be computer storage media able to store instructions, modules or components that may be executed by the processor 502. Further, when mentioned, non-transitory computer-readable media exclude media such as energy, carrier signals, electromagnetic waves, and signals per se.

The memory 504 may be used to store and maintain any number of functional components that are executable by the processor 502. In some implementations, these functional components comprise instructions or programs that are executable by the processor 502 and that, when executed, implement operational logic for performing the actions and services attributed above to the POS device 500. Functional components of the POS device 500 stored in the memory 504 may include a merchant application 518, discussed above. The merchant application 518 may present an interface on the POS device 500 to enable the merchant to conduct transactions, receive payments, and so forth, as well as communicating with the payment service 110 for processing payments and sending transaction information. Further, the merchant application 518 may present an interface to enable the merchant to manage the merchant's account, and the like. The merchant application 518 may also facilitate automatic savings of portions of future revenue, as described above with reference to FIGS. 1 and 2A-B.

Additional functional components may include an operating system 520 for controlling and managing various functions of the POS device 500 and for enabling basic user interactions with the POS device 500. The memory 504 may also store transaction data 522 that is received based on the merchant associated with the POS device 500 engaging in various transactions with customers, such as the example customers 106 from FIG. 1.

In addition, the memory 504 may also store data, data structures and the like, that are used by the functional components. For example, this data may include item information that includes information about the items offered by the merchant, which may include images of the items, descriptions of the items, prices of the items, and so forth. Depending on the type of the POS device 500, the memory 504 may also optionally include other functional components and data, which may include programs, drivers, etc., and the data used or generated by the functional components. Further, the POS device 500 may include many other logical, programmatic and physical components, of which those described are merely examples that are related to the discussion herein.

The network interface(s) 510 may include one or more interfaces and hardware components for enabling communication with various other devices over the network or directly. For example, network interface(s) 510 may enable communication through one or more of the Internet, cable networks, cellular networks, wireless networks (e.g., Wi-Fi) and wired networks, as well as close-range communications such as Bluetooth®, Bluetooth® low energy, and the like, as additionally enumerated elsewhere herein.

FIG. 5 further illustrates that the POS device 500 may include the display 506 mentioned above. Depending on the type of computing device used as the POS device 500, the display 506 may employ any suitable display technology. For example, the display 506 may be a liquid crystal display, a plasma display, a light emitting diode display, an OLED (organic light-emitting diode) display, an electronic paper display, or any other suitable type of display able to present digital content thereon. In some examples, the display 506 may have a touch sensor associated with the display 506 to provide a touchscreen display configured to receive touch inputs for enabling interaction with a graphic interface presented on the display 506. Accordingly, implementations herein are not limited to any particular display technology. Alternatively, in some examples, the POS device 500 may not include the display 506, and information may be present by other means, such as aurally.

The I/O components 508, meanwhile, may include speakers, a microphone, a camera, and various user controls (e.g., buttons, a joystick, a keyboard, a keypad, etc.), a haptic output device, and so forth.

In addition, the POS device 500 may include or may be connectable to a payment instrument reader 512. In some examples, the reader 512 may plug in to a port in the merchant device, such as a microphone/headphone port, a data port, or other suitable port. In other instances, the reader 512 is integral with the entire POS device 500. The reader may include a read head for reading a magnetic strip or chip of a payment card, and further may include encryption technology for encrypting the information read from the magnetic strip. Alternatively, numerous other types of card readers may be employed with the POS devices 500 herein, depending on the type and configuration of a particular POS device 500.

The location component 514 may include a GPS device able to indicate location information, or the location component 514 may comprise another other location-based sensor. The POS device 500 may also include one or more additional sensors (not shown), such as an accelerometer, gyroscope, compass, proximity sensor, and the like. Additionally, the POS device 500 may include various other components that are not shown, examples of which include removable storage, a power control unit, and so forth.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

1. A system comprising:
one or more instances of a point-of-sale (POS) application associated with one or more merchant devices operable by one or more merchants that use a payment processing service for processing one or more transactions; and
the one or more server computing devices associated with the payment processing service comprising one or more processors, and one or more computer-readable media storing computer-executable instructions that, when executed, cause the one or more processors to perform acts comprising:
receiving, from a first instance of the POS application associated with a first merchant device of the one or more merchant devices, first customer data indicating first POS interactions between a customer of one or more customers and a first merchant of the one or more merchants, wherein the first instance of the POS application configures the first merchant device as a first POS terminal and enables the first POS terminal to generate the first customer data and transmit the first customer data to the one or more server computing devices via a network;
receiving, from a second instance of the POS application associated with a second merchant device of the one or more merchant devices, second customer data, wherein the second customer data indicates second POS interactions between the customer and a second merchant of the one or more merchants, wherein the second instance of the POS application configures the second merchant device as a second POS terminal and enables the second POS terminal to generate the second customer data and transmit the second customer data to the one or more server computing devices via the network;
identifying a first merchant profile associated with the payment processing service and a second merchant profile associated with the payment processing service, wherein the first merchant profile and the second merchant profile correspond to the first merchant and the second merchant respectively;
based at least in part on the first merchant profile and the second merchant profile, determining that the second merchant and the first merchant share one or more attributes;
responsive to determining that the second merchant and the first merchant share one or more attributes, assigning a customer-interaction score to the customer based at least in part on the first customer data associated with the customer and the first merchant and the second customer data associated with the customer and the second merchant;
determining that the customer-interaction score of the customer meets or exceeds a threshold;
based at least in part on the customer-interaction score of the customer, predicting a communication preference for communications from the first merchant and the second merchant to the customer, wherein the communication preference corresponds to at least one of a frequency of the communications, an amount of the communications, or a type of the communications; and
based at least in part on the communication preference:
generating a communication to send to the customer on behalf of the second merchant; and
transmitting the communication on behalf of the second merchant directly to a mobile device of the customer without an explicit request from the customer.

2. A system as recited in claim 1, the acts further comprising determining whether the customer has previously explicitly opted in to receive communications from at least one of the first merchant or the second merchant, and wherein assigning the customer-interaction score is further based at least in part on whether the customer has previously explicitly opted in to receive the communications from the at least one of the first merchant or the second merchant.

3. A system as recited in claim 1, the acts further comprising storing, in a remotely located datastore associated with the payment processing service and based at least in part on the customer-interaction score meeting or exceeding the threshold, an indication that the customer opts in to receive future communications from the second merchant.

4. A system as recited in claim 3, the acts further comprising sending to the mobile device of the customer, based at least in part on storing the indication, an opt-in request for the customer to explicitly provide the second merchant permission to send the future communications to the mobile device of the customer.

5. A system comprising:
one or more instances of a point-of-sale (POS) application associated with one or more merchant devices operable by one or more merchants that use a payment processing service for processing one or more transactions; and
one or more server computing devices associated with the payment processing service further comprising one or more processors, and one or more computer-readable media storing computer-executable instructions that, when executed, cause the one or more processors to perform acts comprising:
receiving, from a first instance of the POS application associated with a first merchant device of the one or more merchant devices, first customer data indicating first POS interactions between a customer of one or more customers and a first merchant of the one or more merchants, wherein the first instance of the POS application configures the first merchant device as a first POS terminal and enables the first POS terminal to generate the first customer data and transmit the first customer data to the one or more server computing devices via a network;
receiving, from a second instance of the POS application associated with a second merchant device of the one or more merchant devices, second customer data, wherein the second customer data indicates second POS interactions between the customer and a second merchant of the one or more merchants, wherein the second instance of the POS application configures the second merchant device as a second POS terminal and enables the second POS terminal to generate the second customer data and transmit the second customer data to the one or more server computing devices via the network;
identifying a first merchant profile associated with the payment processing service and a second merchant profile associated with the payment processing service, wherein the first merchant profile and the second merchant profile correspond to the first merchant and the second merchant respectively;
based at least in part on the first merchant profile and the second merchant profile, determining that the second merchant and the first merchant share one or more attributes;
responsive to determining that the second merchant and the first merchant share one or more attributes, assigning a customer-interaction score to the customer based at least in part on the first customer data associated with the customer and the first merchant and the second customer data associated with the customer and the second merchant;
determining that the customer-interaction score of the customer meets or exceeds a threshold;
based at least in part on the customer-interaction score of the customer,
predicting a communication preference for communications from the first merchant and the second merchant to the customer, wherein the communication preference corresponds to at least one of a frequency of the communications, an amount of the communications, or a type of the communications; and
based at least in part on the communication preference:
generating a communication to send to the customer on behalf of the second merchant; and
transmitting the communication on behalf of the second merchant directly to a mobile device of the customer without an explicit request from the customer.

6. A system as recited in claim 5, wherein at least one of the first customer data or the second customer data further indicates at least one of:
customer-location information indicative of how often the mobile device of the customer has been located at a location of the first merchant or second merchant, respectively, over a predetermined amount of time;
an amount of money spent by the customer at the first merchant or second merchant, respectively, over the predetermined amount of time; or
an amount of previous communication between the customer and the first merchant or second merchant, respectively.

7. A system as recited in claim 5, the acts further comprising:
sending, based at least in part on the customer-interaction score of the customer meeting or exceeding the threshold, a first suggestion to the second merchant, the first suggestion indicating that the second merchant engage in communications consistent with the communication preference of the customer.

8. A system as recited in claim 5, the acts further comprising:
storing, based at least in part on the customer-interaction score of the customer meeting or exceeding the threshold, an indication of the communication preference of the customer with respect to the second merchant.

9. A system as recited in claim 5, wherein the communication from the second merchant comprises at least one of a survey, a coupon, a promotion, or a newsletter.

10. A system as recited in claim 5, wherein at least one of the first customer data or the second data further comprises:
first data indicating at least one of an amount of time the customer has spent at a location of the first merchant or second merchant, respectively or how often the customer visits the location of the first merchant or second merchant, respectively, wherein the location of the first merchant or second merchant, respectively, comprises a physical premises of the first merchant or second merchant, respectively, or a digital presence of the first merchant or second merchant, respectively; and
second data indicating at least one of an amount of money spent by the customer at the first merchant or second merchant, respectively, or an item acquired from the first merchant or second merchant, respectively.

11. A system as recited in claim 10, further comprising:
assigning a first weight to the first data; and
assigning a second weight to the second data,
wherein assigning the customer-interaction score is further based at least in part on the first data and the second data relative to the first weight and the second weight respectively, and wherein at least one of the first weight or the second weight decays over time.

12. A system as recited in claim 5, wherein generating the communication comprises generating the communication using content created by the payment processing service.

13. A system as recited in claim 5, wherein at least one of the first customer data or the second data further includes an indication of at least one of (i) an amount of time the customer has spent at a location of the first merchant or second merchant, respectively, (ii) how often the customer visits the location of the first merchant or second merchant, respectively, (iii) an amount of money spent by the customer at the first merchant or second merchant, respectively, or (iv) an item acquired by the customer from the first merchant or second merchant, respectively.

14. A method comprising:
providing, by a payment processing service, one or more instances of a point-of-sale (POS) application to one or more computing devices operable by one or more merchants that use the payment processing service for processing one or more transactions;
receiving, from a first instance of the POS application associated with a first merchant device of the one or more merchant devices, first customer data indicating first POS interactions between a customer of one or more customers and a first merchant of the one or more merchants, wherein the first instance of the POS application configures the first merchant device as a first POS terminal and enables the first POS terminal to generate the first customer data and transmit the first customer data to the one or more server computing devices via a network;
receiving, from a second instance of the POS application associated with a second merchant device of the one or more merchant devices second customer data, wherein the second customer data indicates second POS interactions between the customer and a second merchant of the one or more merchants, wherein the second instance of the POS application configures the second merchant device as a second POS terminal and enables the second POS terminal to generate the second customer data and transmit the second customer data to the one or more server computing devices via the network;
identifying a first merchant profile associated with the payment processing service and a second merchant profile associated with the payment processing service, wherein the first merchant profile and the second merchant profile correspond to the first merchant and the second merchant respectively;
based at least in part on the first merchant profile and the second merchant profile, determining that the second merchant and the first merchant share one or more attributes;
responsive to determining that the second merchant and the first merchant share one or more attributes, assigning a customer-interaction score to the customer based at least in part on the first customer data associated with the customer and the first merchant and the second customer data associated with the customer and the second merchant;
determining that the customer-interaction score of the customer meets or exceeds a threshold;
based at least in part on the customer-interaction score of the customer, predicting a communication preference for communications from the first merchant and the second merchant to the customer, wherein the communication preference corresponds to at least one of a frequency of the communications, an amount of the communications, or a type of the communications; and
based at least in part on the communication preference transmitting a communication on behalf of the second merchant directly to a mobile device of the customer without an explicit request from the user.

15. A method as recited in claim 14, further comprising:
determining additional data indicative of at least one of:
customer-location information indicative of how often the mobile device of the customer has been located at a location of the second merchant over a predetermined amount of time;
an amount of money spent by the customer at the second merchant over the predetermined amount of time; or
an amount of previous communication between the customer and the second merchant; and
assigning the customer-interaction score further based at least in part on the additional data.

16. A method as recited in claim 14, further comprising:
based at least in part on determining that the customer-interaction score meets or exceeds the threshold, sending a suggestion that the second merchant engage in at least one of the frequency of the communications, the amount of the communications, or the type of the communications with the customer.

17. A method as recited in claim 14, further comprising:
storing, in a remotely located datastore associated with the payment processing service and based at least in part on determining that the customer-interaction score meets or exceeds the threshold, the communication preference of the customer with respect to the second merchant.

18. (canceled)

19. A method as recited in claim 14, further comprising:
creating, based at least in part on the second customer data, the communication.

20. A method as recited in claim 14, wherein at least one of the first customer data or the second data further includes an indication of at least one of (i) an amount of time the customer has spent at a location of the first merchant or second merchant, respectively, (ii) how often the customer visits the location of the first merchant or second merchant, respectively, (iii) an amount of money spent by the customer at the first merchant or second merchant, respectively, or (iv) an item acquired by the customer from the first merchant or second merchant, respectively.

21. A system as recited in claim 1, the acts further comprising:
based at least in part on the customer-interaction score of the customer being less than the threshold:
sending a suggestion indicating that the second merchant engage in no contact with the customer; and
storing, in a remotely located datastore associated with the payment processing service, an indication that the customer is to receive the no contact on behalf of the second merchant.
